(19) United States
(12) Patent Application Publication
(10) Pub. No.: US 2013/0304518 A1
(43) Pub. Date: Nov. 14, 2013

(54) METHODS AND SYSTEMS FOR APPRAISING AN OBJECT

(71) Applicant: Charles Kurt Artinger, Belleville, IL (US)

(72) Inventor: Charles Kurt Artinger, Belleville, IL (US)

(21) Appl. No.: 13/470,508

(22) Filed: May 14, 2012

(51) Int. Cl. G06Q 40/08

(52) U.S. Cl. 705/4

(57) ABSTRACT

An appraisal system includes a network device, a processor coupled to the network device, and a memory device coupled to the processor. The memory device includes a plurality of computer-executable instructions that program the processor to establish a connection with a computing device using the network device, receive an identifier of an insurer from the computing device, and present an appraisal template to a user through the computing device. The appraisal template is customized to the insurer based on the identifier, and the appraisal template includes a plurality of appraisal fields for use in appraising an object. The processor is further programmed to receive data within the appraisal fields and generate an appraisal submission based on the data received.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to appraisal systems and, more particularly, to methods and systems for appraising an object.

Items of value are typically insured with insurance companies to offset the cost of replacing the item if an event occurs such that the item needs replacing. For example, jewelry is often insured to enable an owner to offset the cost of replacing the jewelry in the event the jewelry is lost, damaged, or stolen. Typically, after such an event occurs, the owner contacts the insurance company and files a claim to have the jewelry replaced.

An appraisal of the item is often required to establish insurance coverage. The appraisal identifies important characteristics of the item and identifies an appraised value of the item. The appraised value of the item determines a cost of the insurance policy covering the item and may indicate an expected replacement cost for the item. The appraisal of the item is often transmitted electronically and/or physically to an underwriter of the insurance company to determine the risks and/or costs associated with insuring the item. In other cases, an appraisal is faxed, scanned, or physically taken to a local agent of the insurer who may forward the appraisal to the underwriter and/or may enter the data into a customer relationship management (CRM) system. However, at least some known underwriters must enter the data associated with the appraisal and the item characteristics into one or more computer systems used by the underwriter. Such data entry may be time-consuming and may result in data entry errors that may impose undesired financial costs on the underwriter, the insurance company, and/or the owner of the insured item. In addition, a lack of standardized forms or templates may cause hardships for underwriters attempting to interpret the attributes of appraisals.

### BRIEF DESCRIPTION OF THE INVENTION

In one aspect, an appraisal system is provided that includes a network device, a processor coupled to the network device, and a memory device coupled to the processor. The memory device includes a plurality of computer-executable instructions that program the processor to establish a connection with a computing device using the network device, receive an identifier of an insurer from the computing device, and present an appraisal template to a user through the computing device. The appraisal template is customized to the insurer based on the identifier, and the appraisal template includes a plurality of appraisal fields for use in appraising an object. The processor is further programmed to receive data within the appraisal fields and generate an appraisal submission based on the data received.

In another aspect, a method of appraising an object using an appraisal server including a processor and a network device is provided. The method includes establishing a connection between a computing device and the appraisal server using the network device, receiving, by the appraisal server, an identifier of an insurer from the computing device, and presenting, by the appraisal server, an appraisal template to a user through the computing device. The appraisal template is customized to the insurer based on the identifier, and the appraisal template includes a plurality of appraisal fields for use in appraising the object. The method also includes receiving, by the appraisal server, data within the appraisal fields, and generating, by the appraisal server, an appraisal submission based on the data received.

### BRIEF DESCRIPTION OF THE DRAWINGS

FIG. 1 is a block diagram of an exemplary appraisal system.

FIG. 2 is a block diagram of an exemplary appraisal server that may be used with the appraisal system shown in FIG. 1.

FIG. 3 is a flow diagram of an exemplary method for appraising an object that may be implemented by the appraisal system shown in FIG. 1 and the appraisal server shown in FIG. 2.

### DETAILED DESCRIPTION OF THE INVENTION

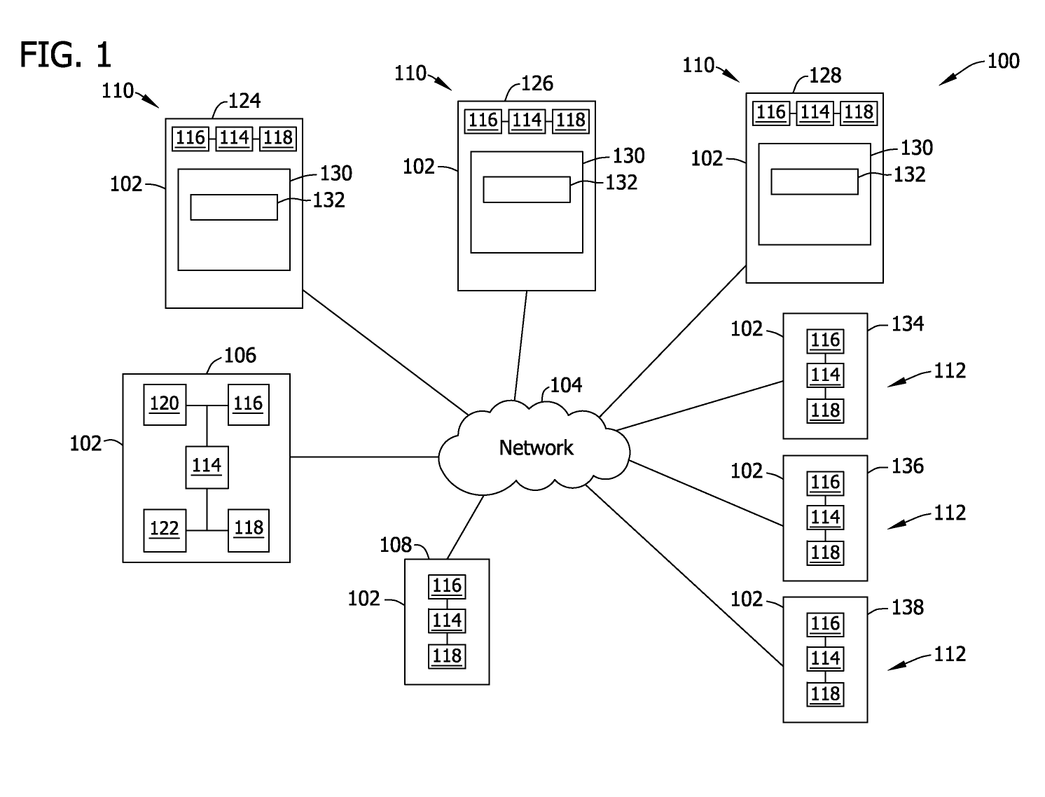

FIG. 1 is a block diagram of an exemplary appraisal system 100. In the exemplary embodiment, appraisal system 100 includes a plurality of computing devices 102 that are coupled together by a network 104, such as the Internet. Computing devices 102 may include, for example, desktop computers, server computers (“servers”), tablet computers, smart phones, and/or any other computing device that enables system to function as described herein.

In the exemplary embodiment, computing devices 102 include an appraiser device 106, an appraisal server 108, at least one server 110 associated with one or more insurers or insurance companies (hereinafter referred to as an “insurer server 110”), and at least one server 112 associated with one or more underwriters or underwriter organizations (hereinafter referred to as an “underwriter server 112”). While appraisal server 108, insurer server 110, and underwriter server 112 are described as servers, it should be recognized that appraisal server 108, insurer server 110, and/or underwriter server 112 may be any computing device 102 that enables appraisal system 100 to function as described herein.

Each computing device 102, in the exemplary embodiment, includes at least one processor 114, at least one memory device 116, and at least one network device 118. Moreover, one or more computing devices 102 may include a display 120 and/or a user input device 122.

Processor 114 includes any suitable programmable circuit including one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above examples are exemplary only, and thus are not intended to limit in any way the definition and/or meaning of the term “processor.”

Memory device 116 includes a computer-readable storage medium, such as, without limitation, random access memory (RAM), flash memory, a hard disk drive, a solid state drive, a diskette, a flash drive, a compact disc, a digital video disc, and/or any suitable memory. In the exemplary embodiment, memory device 116 includes data and/or instructions that are executable by processor 114 to program processor 114 to perform the functions described herein.

Network device 118 may include, without limitation, a network interface controller (NIC), a network adapter, a transceiver, a public switched telephone network (PSTN) interface controller, or any other device that enables appraisal system 100 to operate as described herein. Network device 118 may connect to network 104 using any suitable communication protocol, such as a wired Ethernet protocol or a wireless Ethernet protocol.

Display 120 includes, without limitation, a liquid crystal display (LCD), a cathode ray tube (CRT), a plasma display, a light-emitting diode (LED) display, and/or any suitable visual output device capable of displaying graphical data and text to a user. User input device 122 includes, without limitation, a keyboard, a keypad, a touch-sensitive screen, a scroll wheel, a pointing device, an audio input device employing speech-recognition software, and/or any suitable device that enables a user to input data into network device 118 and/or retrieve data from network device 118. In one embodiment, display 120 and user input device 122 may be integrated, such as within a touch sensitive screen.

Appraiser device 106 includes, for example, processor 114, memory device 116, network device 118, display 120, and user input device 122 that are each coupled to processor 114. In the exemplary embodiment, appraiser device 106 is used by an appraiser to appraise an object of value. The appraiser may use appraiser device 106 to perform an initial appraisal of the object, or may be used to reappraise the object to validate proper insurance coverage for the object, for example. The object may include, for example, a painting, a diamond ring, a necklace, a vehicle, and/or any other object of value. As used herein, an “appraiser” is an individual who appraises an object. As used herein, the term “appraise” or “appraisal” refers to establishing a value, such as a monetary value, of an object based on characteristics of the object. The appraiser uses appraiser device 106 to connect to appraisal server 108 to submit an appraisal of one or more objects.

Appraisal server 108 receives data from one or more appraisers via one or more appraiser devices 106, either concurrently or at discrete points in time, and generates one or more appraisal submissions based on the data received. The appraisal server 108 transmits the appraisal submissions to one or more underwriter servers 112, as is more fully described below.

In the exemplary embodiment, appraisal system 100 includes a plurality of insurer servers 110, such as a first insurer server 124, a second insurer server 126, and a third insurer server 128. While FIG. 1 illustrates three insurer servers 110, it should be recognized that appraisal system 100 may include any suitable number of insurer servers 110 that enables appraisal system 100 to function as described herein. Each insurer server 110 includes, or hosts, a webpage 130 that includes a link 132 to appraisal server 108. In the exemplary embodiment, link 132 is a hyperlink 132 that identifies a uniform resource locator (URL) or other information that enables appraiser device 106 to connect to appraisal server 108 when the appraiser accesses, or “clicks on,” link 132. Accordingly, links 132 of a plurality of webpages 130 and/or insurer servers 110 direct the appraiser to a single appraisal server 108 for appraising an object.

Moreover, in the exemplary embodiment, appraisal system 100 includes a plurality of underwriter servers 112, such as a first underwriter server 134, a second underwriter server 136, and a third underwriter server 138. While FIG. 1 illustrates three underwriter servers 112, it should be recognized that appraisal system 100 may include any suitable number of underwriter servers 112 that enables appraisal system 100 to function as described herein. In the exemplary embodiment, each underwriter server 112 is associated with an underwriter, which is in turn associated with an insurer. Underwriter servers 112 receive the appraisal submission and analyze the submission, for example, to determine whether an insurance policy should be issued to insure the object.

During operation, the appraiser uses appraiser device 106 to establish a connection to an insurer server 110 for an insurer to whom the appraiser wants to submit an appraisal. The appraiser may enter a username and password, or other access credentials to view webpage 130. If the appraiser is reappraising the object, for example, to determine whether the object is sufficiently insured, or “covered,” by an insurance policy, the appraiser may enter the insurance policy number or an encrypted key, for example, on the webpage 130 to access the insurance policy details for the object.

Moreover, the appraiser uses appraiser device 106 to select link 132 and navigate to appraisal server 108. Appraiser device 106 establishes a connection to appraisal server 108, and passes an identifier to appraisal server 108 that is indicative of the insurer and/or insurer server 110 that referred, or linked, appraiser device 106 to appraisal server 108 (hereinafter referred to as the “referring insurer”) using link 132. The identifier may include, for example, data included within a hypertext transfer protocol (HTTP) referer field after link 132 is accessed, data embedded within link 132, a cookie that includes data representative of the referring insurer, and/or any other data that enables appraisal server 108 to identify the referring insurer.

Appraisal server 108 receives the identifier and presents an appraisal template (not shown in FIG. 1) to the appraiser through appraiser device 106. The appraisal template is customized or adjusted based on the referring insurer (i.e., based on the identifier). The appraiser fills out the appraisal template by entering data representative of the characteristics of the object, including an appraised value (or appraisal) of the object. Appraisal server 108 generates an appraisal submission based on the data, and transmits the appraisal submission to one or more underwriter servers 112. In the exemplary embodiment, the appraisal submission is automatically entered directly into a database or another data system of underwriter server 112. The underwriter may analyze the appraisal submission and determine whether an insurance policy should be issued for the object, a cost of the insurance policy, and/or a coverage limit or amount of coverage to be provided for the object under the insurance policy. The underwriter may communicate with the insurer to recommend issuing the insurance policy, for example.

While underwriters and insurers, and computing devices 102 of underwriters and insurers, have been described as separate entities, it should be recognized that underwriters may be a part of an insurer's organization. Accordingly, underwriter servers 112 may be the same servers as insurer servers 110 and/or underwriter servers 112 may be coupled to insurer servers 110 by a network different from network 104, such as by a local area network.

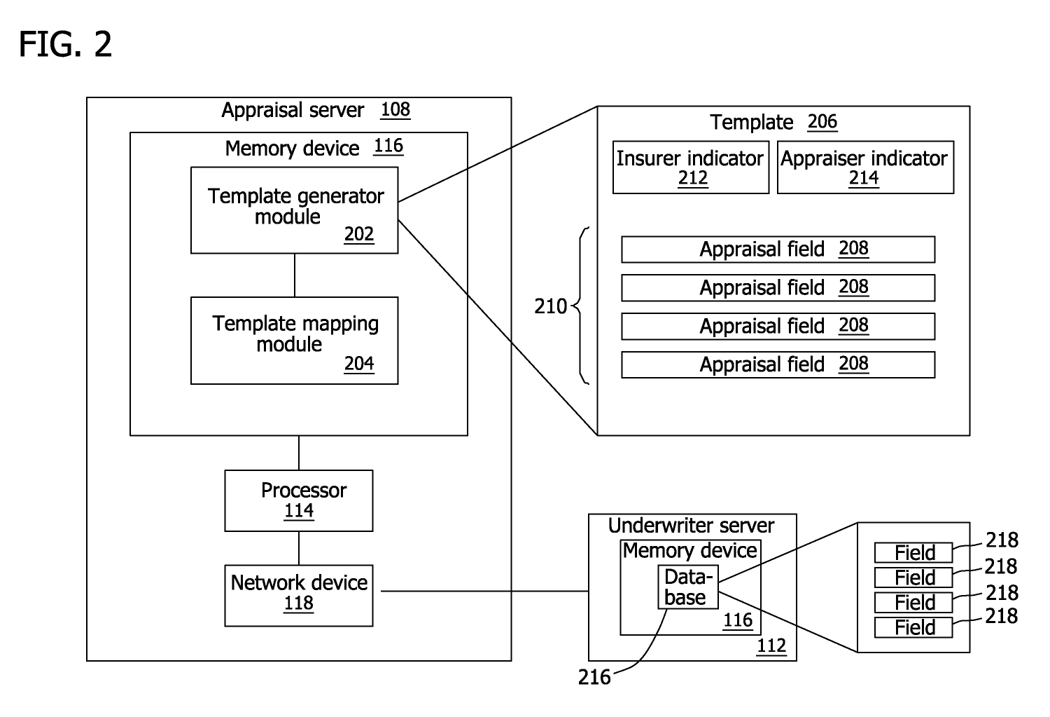

FIG. 2 is a block diagram of an exemplary appraisal server 108 that may be used with appraisal system 100 (shown in FIG. 1). In the exemplary embodiment, appraisal server 108 includes memory device 116 and network device 118 that are each coupled to processor 114. Memory device 116 includes a plurality of program modules executable by processor 114, such as a template generator module 202 and a template mapping module 204.

Template generator module 202 is executed by processor 114 to provide a template 206 that is customized to the referring insurer and/or to the appraiser that is appraising the object. Template generator module 202 may use a default template as a base, and may customize or adjust the default template based on predefined rules or requirements specific to the referring insurer and/or the appraiser to provide template 206. For example, a particular insurer may require that an appraiser include additional fields in an appraisal submission than the fields that are included in the default template. Accordingly, in one embodiment, template generator module 202 may generate template 206 by adding the additional fields to the default template. In another embodiment, template generator module 202 may remove fields from the default template that are not required by an insurer to generate template 206. In yet another embodiment, one or more customized templates 206 are associated with separate insurers and are stored in memory device 116. The customized template 206 associated with the referring insurer is retrieved from memory device 116 by template generator module 202 when the referring insurer is identified as described above with reference to FIG. 1.

Template 206 includes a plurality of appraisal fields 208 into which data may be entered to form an appraisal submission 210. In the exemplary embodiment, template 206 is a web-based template 206 that displays a plurality of appraisal fields 208 to an appraiser and enables the appraiser to enter data into appraisal fields 208 displayed. In one embodiment, template 206 is embodied within a plurality of webpages linked together such that one or more appraisal fields 208 are displayed on a first webpage, one or more appraisal fields 208 are displayed on a second webpage, and one or more appraisal fields 208 are displayed on a third webpage, for example.

In the exemplary embodiment, each appraisal field 208 includes a field name that identifies the field, and field data that includes the data entered by the appraiser. Appraisal fields 208 may include, for example, appraiser contact and/or business information, a type of object being appraised (e.g., jewelry, household item, fine art, etc.), and/or any other field that enables appraisal server 108 to function as described herein. In the exemplary embodiment, the appraiser may select the type of object being appraised to view additional appraisal fields 208 specific to the selected object type. For example, if the appraiser selects “jewelry” as the type of object, and selects a subtype of “ring” from an appraisal field representing a secondary object type, a plurality of appraisal fields 208 specific to jewelry rings is displayed within template 206. Appraisal fields 208 specific to jewelry rings may include, for example, a metal type for the ring, a weight of a mounting for one or more gemstones, a type, weight, shape, color, cut, clarity, and/or grade of one or more gemstones, and/or any other field that enables appraisal server 108 to function as described herein. Moreover, appraisal fields 208 may include a field for the appraised value of the object. The appraised value of the object may be input by the appraiser, or may be automatically generated by appraisal server 108 based on the data input into appraisal fields 208 and/or based on data received from sources separate from the appraiser, such as market conditions and/or market prices of one or more components of the object.

Appraisal fields 208 may be identified as required appraisal fields 208 and optional appraisal fields 208. Required appraisal fields 208 are fields that must be completed before appraisal submission 210 is deemed to be complete. Optional appraisal fields 208 are fields that do not need to be completed before appraisal submission 210 is deemed to be complete. In the exemplary embodiment, appraisal server 108 will flag or otherwise highlight required appraisal fields 208 that have not been completed if the appraiser attempts to submit appraisal submission 210.

An insurer indicator 212 may be included within template 206 to identify the referring insurer. For example, insurer indicator 212 may include a logo of the insurer, a name of the insurer, an image associated with the insurer, and/or any other suitable data. It should be recognized that customized template 206 and/or insurer indicator 212 may be automatically loaded or presented by template generator module 202 when appraisal server 108 receives the identifier of the referring insurer.

Moreover, an appraiser indicator 214 may be included within template 206 to identify the appraiser to the underwriter and/or to any other suitable party. For example, appraiser indicator 214 may include a logo of the appraiser, a name of the appraiser, an image associated with the appraiser, and/or any other suitable data. Insurer indicator 212 and/or appraiser indicator 214 may be included within appraisal submission 210, or may be omitted from submission 210. The appraiser may access a “submit” button, or another suitable button or link, to complete and submit appraisal submission 210 to one or more underwriters and/or to one or more agents of the insurer, for example. It should be recognized that appraisal submission 210 may be submitted to underwriters and/or agents to update a prior appraisal of the object, or as a new appraisal for an object purchased, for example, at a point-of-sale (POS).

Template mapping module 204 receives appraisal submission 210 and reformats, or “maps,” appraisal submission 210 to a data framework specific to one or more underwriters. More specifically, in the exemplary embodiment, each underwriter server 112 includes a database 216 or another data structure within memory device 116 of underwriter server 112. Database 216 includes data representative of one or more appraisal submissions 210 received from appraisal server 108 and/or from other sources. Database 216 stores appraisal submissions 210 in a plurality of underwriter fields 218 that may be different from appraisal fields 208. For example, a name of an appraisal field 208 may be different from a name of a corresponding underwriter field 218 even though appraisal field 208 and underwriter field 218 are designed to store the same data or the same type of data.

Template mapping module 204 maps appraisal fields 208 to underwriter fields 218 based on predetermined field mapping templates or sets of rules stored in memory device 116. As part of the mapping process, data may be converted from one format to another format. For example, appraisal field 208 may store data in United States customary measurement units and underwriter field 218 may store data in metric units. Accordingly, template mapping module 204 may convert data in appraisal field 208 from United States customary units to metric units for storing the data in underwriter field 218. It should be recognized that each underwriter may use different underwriter fields 218. Template mapping module 204 may therefore use a different field mapping template or set of rules to map appraisal fields 208 to underwriter fields 218 for each underwriter.

In one embodiment, appraisal fields 208 are substantially similar to underwriter fields 218 such that no mapping is necessary. For example, appraisal template 206 may be selected or configured such that appraisal fields 208 match underwriter fields 218.

When the appraisal is complete, appraisal submission 210 is transmitted to underwriter server 112. In the exemplary embodiment, appraisal submission 210 is transmitted directly from appraisal server 108 to database 216 and/or underwriter fields 218, such that data entered into appraisal fields 208 is entered into underwriter fields 218, after any required field mappings have been performed. Accordingly, no additional data entry is required to input appraisal submission 210, and/or the data contained in appraisal submission 210, into underwriter server 112. Appraisal system 100 therefore facilitates improving an efficiency and an accuracy of submitting appraisals of objects from appraisers to underwriters and/or insurers as compared to at least some known prior art systems.

In one embodiment, appraisal system 100 validates or verifies an accuracy of appraisal submission 210 (also referred to as a “current appraisal submission 210), or of another appraisal submission 210. For example, appraisal server 108 may store a plurality of historical appraisal submissions 210 representative of appraisals of the object or of similar objects performed at prior points in time. Moreover, a database, such as database 216, or another data storage device or component may store information, or may receive downloaded information such as market pricing, regarding the value of the object or of similar objects. Historical appraisal submissions 210 and/or information from the database may be used to validate current appraisal submission 210, for example, if the characteristics of the objects of historical appraisal submissions 210 (i.e., as set forth in appraisal fields 208 of historical appraisal submissions 210) and/or of the database are substantially similar to the characteristics and/or appraisal fields 208 of the object of current appraisal submission 210. If the appraised value of the object of current appraisal submission 210 is substantially higher or lower than the appraised values of similar objects, appraisal server 108 may flag current appraisal submission 210 as being invalid or at risk of being invalid, or may transmit a message to underwriters, insurers, and/or the appraiser indicating that the appraisal is invalid or at risk of being invalid. Underwriters and/or insurers may cause a new appraisal to be performed for the object and/or may cause a different appraiser to perform the appraisal.

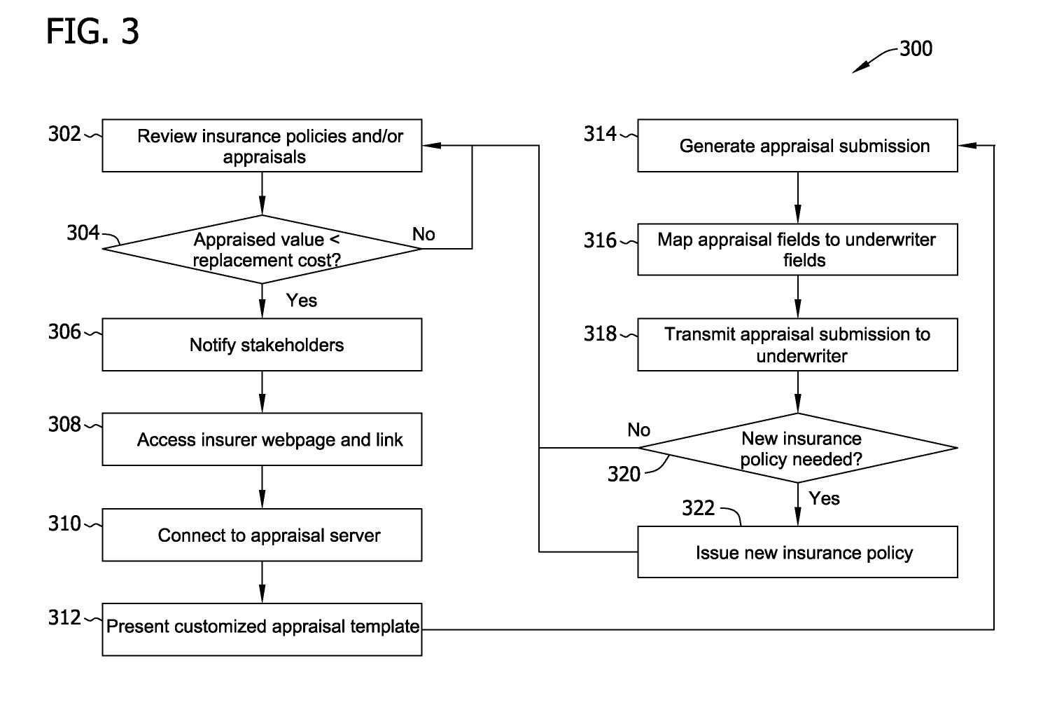

FIG. 3 is a flow diagram of an exemplary method 300 for appraising an object. Method 300 may be used with appraisal system 100 and/or appraisal server 108 (both shown in FIG. 1). Method 300 is embodied within a plurality of computer-executable instructions stored in one or more memory devices 116 (shown in FIG. 1). The instructions are executed by one or more processors 114 (shown in FIG. 1) to perform the functions described herein. While method 300 is described herein as being implemented by appraisal server 108, it should be recognized that any computing device 102 (shown in FIG. 1) of appraisal system 100 may be used to perform method 300.

Method 300 includes reviewing 302 one or more insurance policies and/or appraisals for one or more objects. In the exemplary embodiment, appraisal server 108 or another computing device 102 within appraisal system 100 reviews the insurance policies and/or appraisals for an insurer, for example.

Appraisal server 108 determines 304 whether an appraised value of the object insured by the insurance policy is less than a replacement cost of the object. In one embodiment, appraisal server 108 receives market data, or any other data, indicative of whether a replacement cost for replacing the object has increased since a time that an appraisal was performed on the object. For example, if the cost of gold has increased substantially since the appraisal had been performed, appraisal server 108 may determine that a replacement cost for a gold ring may have increased such that the appraised value of the insured object (i.e., the gold ring) is less than the replacement cost. Accordingly, appraisal server 108 may use the market data, or any other data, to determine 304 whether the appraised value of the object is less than the replacement cost of the object. If the appraised value is not less than the replacement cost, no action is taken and method 300 returns to reviewing 302 other insurance policies and/or appraisals.

If the appraised value is less than the replacement cost, appraisal server 108 notifies 306 one or more stakeholders of the insurance policy. The stakeholders may include, for example, an insurance agent, the insured (also known as the policyholder), the insurer, the appraiser, and/or any other party that enables method 300 to function as described herein. Appraisal server 108 may notify 306 the insurance agent and/or the insurer by transmitting an e-mail to the agent and/or the insurer indicating that the insurance policy and/or the appraisal needs to be updated. Appraisal server 108 may notify 306 the insured that the insurance policy and/or the appraisal needs to updated by causing a letter to be transmitted to the insured. The letter may include instructions for an appraiser to access appraisal server 108 to perform a new appraisal or a reappraisal of the object and/or a suggested timeline for completing the appraisal. Alternatively, any suitable notification may be transmitted to the stakeholders that enables method 300 to function as described herein.

If the insured requests a new appraisal of the object, the appraiser accesses 308 a webpage 130 of the insurer and accesses link 132 within webpage 130 to perform the appraisal, for example, using appraiser device 106. Appraiser device 106 connects 310 to appraisal server 108 and transmits the identifier of the referring insurer, as described above with reference to FIG. 1.

Appraisal server 108 presents 312 a customized appraisal template, such as appraisal template 206 (shown in FIG. 2), to the appraiser. Appraisal template 206 is customized based on the rules or requirements specific to the referring insurer, as described above. The appraiser generates 314 an appraisal submission 210 by entering data into appraisal fields 208 of appraisal template 206. Appraisal fields 208 of appraisal submission 210 are mapped 316 to a plurality of underwriter fields 218 to facilitate reducing an amount of data entry that an underwriter is required to complete. Appraisal submission 210 (as modified by the field mapping above) is transmitted 318 to the underwriter, such as to underwriter server 112.

In one embodiment, appraisal submission 210 is transmitted to an agent of the insurer and/or to the insured for approval before appraisal submission 210 is mapped 316 to underwriter fields 218 and transmitted 318 to the underwriter. For example, appraisal submission 210 may be submitted to an agent and/or to the insured for approval of a cost or premium of the appraisal by the agent and/or by the insured. Appraisal submission 210 may therefore be placed “on hold” until the agent and/or the insured approve the submission. Once approved, appraisal submission 210 may be mapped 316 to underwriter fields 218 and transmitted 318 to the underwriter as described above.

The underwriter analyzes appraisal submission to determine 320 whether to issue a new insurance policy or an updated insurance policy (e.g., whether the cost of the insurance coverage needs to be adjusted based on the appraisal and/or the replacement cost for the object). If a new insurance policy is not needed, method 300 returns to reviewing 302 other insurance policies and/or appraisals. If a new insurance policy is needed, the insurer issues 322 a new policy for the object. Method 300 returns to reviewing 302 other insurance policies and/or appraisals.

A technical effect of the systems and methods described herein includes at least one of (a) establishing a connection between a first computing device and an appraisal server using a network device of the appraisal server; (b) receiving, by an appraisal server, an identifier of an insurer from a first computing device; (c) presenting, by an appraisal server, an appraisal template to a user through a first computing device, wherein the appraisal template is customized to an insurer based on an identifier, and wherein the appraisal template includes a plurality of appraisal fields for use in appraising an object; (d) receiving, by an appraisal server, data within a plurality of appraisal fields; and (e) generating, by an appraisal server, an appraisal submission based on data received within a plurality of appraisal fields.

Exemplary embodiments of systems and methods that facilitate appraisals of objects are described above in detail. The systems and methods are not limited to the specific embodiments described herein, but rather, components of each system and steps of each method may be utilized independently and separately from other components and/or steps described herein. For example, each system component and/or each step of the methods described above can also be used in combination with other insurance and/or appraisal systems and methodology.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An appraisal system comprising:
a network device;
a processor coupled to said network device; and
a memory device coupled to said processor, said memory device comprising a plurality of computer-executable instructions that configure said processor to:
establish a connection with a computing device using said network device;
receive a first identifier of an insurer and a second identifier of a type of object being appraised from the computing device;
identify, from a plurality of appraisal templates, a first appraisal template based on the first identifier and the second identifier, wherein the first appraisal template is customized to the insurer and the type of object being appraised and includes a plurality of appraisal fields customized to the type of object being appraised for use in appraising an object, wherein the first appraisal template is generated using a template generator module and a template mapping module;
present the first appraisal template to a user through the computing device;
receive data within the appraisal fields; and
generate an appraisal submission based on the data received.

2. An appraisal system in accordance with claim 1, wherein said processor is further configured to transmit the appraisal submission to a server associated with at least one of an underwriter and an agent for the insurer using said network device.

3. An appraisal system in accordance with claim 2, wherein the server associated with the underwriter includes a memory device and a plurality of underwriter fields stored within the memory device, said processor is further configured to map the plurality of appraisal fields to the plurality of underwriter fields to such that the data received within the appraisal fields is automatically entered within the plurality of underwriter fields by the processor.

4. An appraisal system in accordance with claim 1, wherein said processor is further configured to validate the appraisal submission.

5. An appraisal system in accordance with claim 4, wherein the appraisal submission is a current appraisal submission, said processor is further configured to validate the current appraisal submission using at least one of a historical appraisal submission and information received from a database.

6. An appraisal system in accordance with claim 1, wherein the appraisal submission is a current appraisal submission, said processor is further configured to store a historical appraisal submission associated with the object within said memory device.

7. An appraisal system in accordance with claim 6, wherein said processor is further configured to:
determine to update the historical appraisal submission; and
receive the current appraisal submission to update the historical appraisal submission.

8. An appraisal system in accordance with claim 7, wherein the object is insured by an insurance policy, said processor is further configured to determine that a replacement cost for the object insured by the insurance policy exceeds an appraised value of the object based on at least one of the historical appraisal submission and information received from a database.

9. An appraisal system in accordance with claim 8, wherein said processor is further configured to determine to update the historical appraisal submission based on the determination that the replacement cost exceeds the appraised value.

10. An appraisal system in accordance with claim 9, wherein said processor is further configured to notify a policyholder of the insurance policy upon the determination that the replacement cost exceeds the appraised value.

11. A method of appraising an object using an appraisal server including a processor and a network device, said method comprising:
establishing a connection between a computing device and the appraisal server using the network device;
receiving, by the appraisal server, a first of an insurer and a second identifier of a type of object being appraised from the computing device;
identifying, by the appraisal server, a first appraisal template from a plurality of appraisal templates based on the first identifier and the second identifier, wherein the first appraisal template is customized to the insurer and the type of object being appraised and includes a plurality of appraisal fields customized to the type of object being appraised for use in appraising the object, wherein the first appraisal template is generated using a template generator module and a template mapping module;
presenting the first appraisal template to a user through the computing device;
receiving, by the appraisal server, data within the appraisal fields; and
generating, by the appraisal server, an appraisal submission based on the data received.

12. A method in accordance with claim 11, further comprising transmitting the appraisal submission to a server associated with at least one of an underwriter and an agent for the insurer using the network device.

13. A method in accordance with claim 12, wherein the server associated with the underwriter includes a memory device and a plurality of underwriter fields stored within the memory device, said method further comprising mapping the plurality of appraisal fields to the plurality of underwriter fields such that the data received within the appraisal fields is automatically entered within the plurality of underwriter fields.

14. A method in accordance with claim 11, further comprising validating the appraisal submission.

15. A method in accordance with claim 14, wherein the appraisal submission is a current appraisal submission, said method further comprising validating the current appraisal submission using at least one of a historical appraisal submission and information received from a database.

16. A method in accordance with claim 11, wherein the appraisal submission is a current appraisal submission, said method further comprising storing a historical appraisal submission associated with the object within the appraisal server.

17. A method in accordance with claim 16, further comprising:
determining to update the historical appraisal submission; and
receiving the current appraisal submission to update the historical appraisal submission.

18. A method in accordance with claim 17, wherein the object is insured by an insurance policy, said method further comprising determining that a replacement cost for the object insured by the insurance policy exceeds an appraised value of the object based on at least one of the historical appraisal submission and information received from a database.

19. A method in accordance with claim 18, said method further comprising determining to update the historical appraisal submission based on the determination that the replacement cost exceeds the appraised value.

20. A method in accordance with claim 19, further comprising notifying a policyholder of the insurance policy upon the determination that the replacement cost exceeds the appraised value.
